(19) United States
(12) Patent Application Publication
(10) Pub. No.: US 2003/0131316 A1
(43) Pub. Date: Jul. 10, 2003

(54) Internationalizing SGML documents

(76) Inventors: Kyle Brown, Apex, NC (US); Francis DiNardo, Pittsboro, NC (US); Julie Strong, Hillsborough, NC (US); Robert Thimsen, Apex, NC (US); Skyler Thomas, Fuquay Varina, NC (US)

Correspondence Address: Stephen J. Weed, Esquire, Synnestvedt & Lechner LLP, 2600 Aramark Tower, 1101 Market Street, Philadelphia, PA, 19107-2950, US

(21) Appl. No.: 10/041,057

(22) Filed: Jan. 7, 2002

(51) Int. Cl. G06F 17/00

(52) U.S. Cl. 715/513

(57) ABSTRACT

A method for modifying files for display on a browser. The method includes identifying a file having a section marked with an identifier, receiving an indicator, and filtering the file to modify the section based on the indicator. The files are filtered such that the identifier is removed if the indicator is a default indicator and the identifier and marked section are replaced with a replacement section correspondence to the indicator if the indicator is not the default indicator. In addition, the present invention encompasses a system and computer program product for carrying out the inventive method. The method, system, and computer program product may be used to internationalize files for display on browsers over the Internet such that the files are displayed in a language indicated by the browser.

### FIELD OF THE INVENTION

The present invention relates to displaying files and, more particularly, to internationalizing files for display on a web browser.

### BACKGROUND OF THE INVENTION

The World Wide Web (WWW), e.g., the Internet, enables access to information stored in files around the globe. The files may be accessed by users via web pages displayed on browsers. Preferably, the files are internationalized, meaning that the language in which the files are displayed on a browser will depend upon which language(s) the user of the browser prefers. The preferred language may be established based upon a language selected by the user on a web page, a language preference setting of the browser selected by the user, or a language preference setting of the browser set when the browser was installed.

To understand how files are displayable on a browser in multiple languages, it helps to understand how files are coded for display on a browser. FIG. 1 depicts a common file format used to display information on a browser. The file format depicted in FIG. 1 is hypertext markup language (HTML), a well-known markup language used in files for display over the WWW. HTML is a derivative of SGML (Standard Generalized Markup Language), which is a known standard for markup languages. An HTML file uses natural language “tags” such as <HEAD> and <BODY> to identify text in the header and body of a file, respectively. Typically, the tags consist of an opening tag, e.g., <HEAD>, and a closing tag, e.g., </HEAD>, that are inserted before and after the text, respectively, to identify the text. In addition, formatting tags such as <BOLD> are used to identify how sections of the text are to be displayed. For example, placing the <BOLD> tag preceding a section of text and the </BOLD> tag following the section of text, results in that section of text being displayed on a browser in bold type.

HTML files reside on remote servers accessible via the WWW using a browser. When an HTML file is requested and displayed by the browser, the tags are removed and the text identified by the tags is displayed on the browser. For example, the text “Internationalization Demo” identified in FIG. 1 by the heading tags <HEAD> and </HEAD> will result in the text “Internationalization Demo” being displayed as a header on a browser as depicted in FIG. 1A. The tags placed around the text are simply used to identify text to be formatted and “instruct” the browser how to display that text. Therefore, the resultant text of the HTML file to be displayed on a browser can be determined simply by viewing the HTML file.

In order to display the text of FIG. 1A in a language other than English, several common methods have been employed. These methods include variable text substitution systems and separate file substitution systems. These prior art methods have inherent limitations that decrease their effectiveness for internationalizing files, as described below.

In variable text substitution systems, variables are used to represent sections of text within a file identified for internationalization. For example, in the file depicted in FIG. 1, a first variable such as <SUB HEAD> may be substituted for the text “Internationalization Demo” and a second variable such as <SUB BODY1> may be substituted for the text “Welcome.” Typically, all text within an HTML file that will actually be displayed on a browser will be represented by a variable for substitution. The breakdown of sections of text within the HTML file may be based on essentially any criteria selected by a programmer of the file. For example, the sections of text may be broken down based on paragraphs, with each paragraph having a unique variable to facilitate substitution with appropriate text.

When an internationalization file incorporating variable text substitution is requested by a browser, a known retrieval program co-located with the internationalization file uses the variables within the file to retrieve text in a preferred language from one or more separate files. The retrieved text is substituted for the variables by the retrieval program and the resultant file after substitution is passed to the browser for display.

Variable text substitution systems require that substitutions be performed for each desired language, including the language in which the file is originally written, thereby requiring increased processing time for all languages. Also, since only variables are displayed in the internationalization file, the textual output of the file that will be displayed on a browser cannot be determined simply by viewing the file, i.e., readability is diminished. In addition, the information retrieved by the variables for individual sections is text only and does not include formatting codes. Accordingly, formatting of the text in the internationalization file is applied to the entire section and cannot be applied to portions of individual sections.

In separate file substitution systems, a complete file is created for each language in which the information will be available. The file associated with the preferred language of a user is then selected for display by the browser. Since complete separate files are created for each language, a relatively large area of memory is required for storage of all the files, thereby leading to increased memory requirements. The increased memory requirements are due to memory requirements for the text associated with the individual languages and for duplicate coding in each file, such as embedded images and formatting, that is not dependent on the individual languages. In addition, use of separate files for each language requires that all files be updated when a change is implemented, thereby leading to increased administrative and programming costs.

Accordingly, there is a need for internationalizing methods which overcome the aforementioned limitations relating to readability, formatting, conversion speed, memory requirements, and costs. The present invention fulfills this need among others.

### SUMMARY OF THE INVENTION

The present invention is a method of internationalizing files for display on a browser by which sections of a file to be internationalized are marked with unique identifiers, and then filtered based on an indicator received from the browser that indicates the language in which the file is to be displayed. Filtering is accomplished by removing the unique identifiers if the indicator is a default indicator (indicating that the language of the file matches the language preference setting on the browser or is an unrecognized language) or substituting the unique identifiers and marked sections with replacement sections corresponding to the language identified by the indicator if the indicator is not a default indicator.

One aspect of the present invention is a method for manipulating files. The method includes identifying a file having a first section marked with a first identifier, receiving an indicator, and filtering the file to modify the first section based on the indicator. In addition, the present invention encompasses a system and computer program product for carrying out the inventive method.

### BRIEF DESCRIPTION OF THE DRAWINGS

FIG. 1 is a program code listing of a prior art file;

FIG. 1A is a display of the program code of FIG. 1;

FIG. 2 is a flow chart of a method in accordance with the present invention;

FIG. 2A is a flow chart of the filtering step of FIG. 2;

FIG. 3 is a program code listing of a file in accordance with the present invention;

FIG. 3A is a replacement file for use with the program code listing of FIG. 3;

FIG. 3B is the program code listing of FIG. 3 as modified by the information of FIG. 3A in accordance with one aspect of the present invention;

FIG. 3C is a display of the program code of FIG. 3 for a non-default indicator;

FIG. 4 is a block diagram illustrating an exemplary data processing network in which the present invention may be practiced; and

FIG. 5 is a block diagram of a processing device in which the present invention may be practiced.

### DETAILED DESCRIPTION OF THE INVENTION

The present invention is particularly useful, but not exclusively so, for internationalizing markup language files, such as HTML files, for display over the Internet on a browser such that information will be displayed in a language associated with the browser. Conceptually, in an internationalization embodiment, sections of a markup language file for display on a browser in a language associated with the browser are selected and marked with unique internationalization identifiers to create an internationalization file. When the browser requests the internationalization file for display, along with the request, a language indicator associated with the browser is passed by the browser to a server where the internationalization file resides. A novel program (referred to herein as the “parser program”), which is preferably co-located with the internationalization file, filters the internationalization file based on the language indicator in a novel manner to produce a file for display on the browser in the indicated language. Replacement sections in selected languages corresponding to the identified sections are stored in a location accessible by the parser program for languages other than the language of the internationalization file.

If the language indicator matches the language of the internationalization file or is a language for which replacement sections do not exist, the language indicator is treated as a default indicator and the unique internationalization identifiers are simply removed from the internationalization file prior to its passage to the browser for display in the default language. If the language indicator matches a language for which replacement sections exist, the unique internationalization identifiers and the sections marked by the unique internationalization identifiers in the internationalization file are replaced with corresponding replacement sections in the indicated language that do not include unique internationalization identifiers prior to the passage of the file to the browser for display in the indicated language. Accordingly, since the internationalization identifiers are no longer present after filtering, known browsers may display the filtered internationalization file in their associated languages in accordance with the present invention without the need for modification.

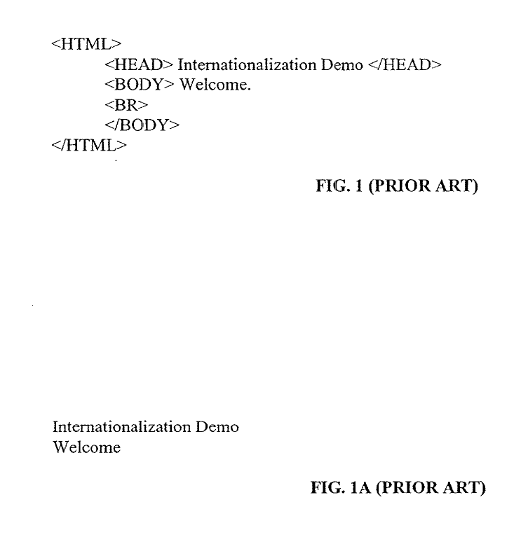

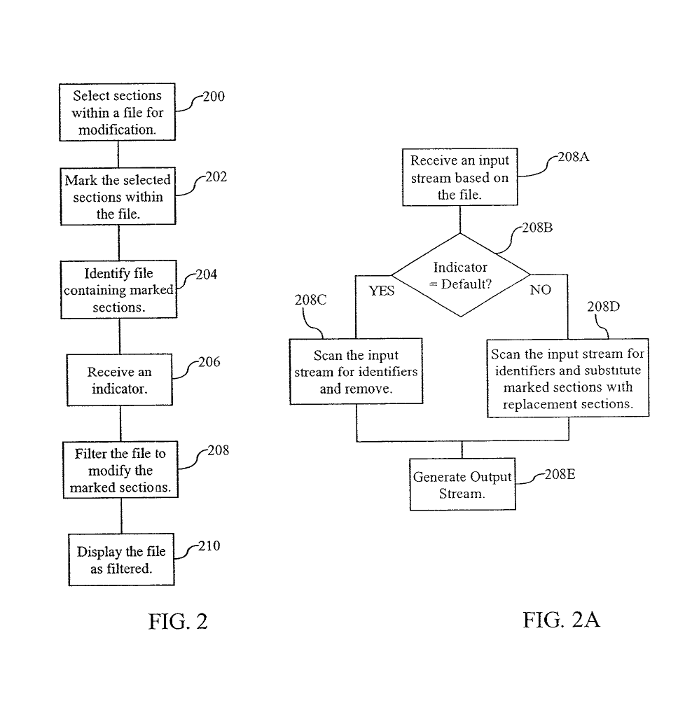

FIG. 2 is a flow chart setting forth steps in accordance with one embodiment of the present invention. Referring to FIG. 2, at step 200, sections within a file are selected for modification. The file may be a markup language file such as the prior art HTML file depicted in FIG. 1, an Extensible Markup Language (XML) file, or a Java Server Pages (JSP) file that incorporates Java and HTML coding. In one embodiment, the sections selected for modification are sections for which internationalization may be desirable, i.e., sections to be modified so that the text is displayed in a language on a browser that matches the language preference associated with the browser. For example, in the file of FIG. 1, the text between the HTML tags <HEAD> and </HEAD> and the text between the HTML tags <BODY> and </BODY> would be selected for internationalization. In addition to text, other features, such as formatting and embedded objects, may be selected for modification. The sections can be selected manually or by using a software program configured to select the sections based on certain HTML tags, for example.

In the preferred embodiment, the language in which the file is originally written is considered the default language of the file and the parser program is configured to recognize it as such. The default language of the HTML file depicted in FIG. 1 is English and its output displayed on a browser can be easily interpreted by someone skilled in HTML programming, and able to read English, by simply viewing the HTML file. It is understood, however, that the default language can be any language.

At step 202, the sections selected in step 200 are marked. Each selected section is marked with a unique identifier to mark specific selected sections for substitution by specific corresponding replacement sections, described below. For example, a first paragraph selected as a first selected section would be marked with a first unique identifier and a second paragraph selected as a second selected section would be marked with a second unique identifier different from the first unique identifier. Replacement sections corresponding to substitution.

In one embodiment, the unique identifiers are “HTML-type” tags to ensure compatibility with known HTML validation systems. HTML-type tags are tags that use a conventional HTML tag format including “angle bracket notation” and opening/closing tags. The opening and closing tags are placed immediately preceding and following the identified sections, respectively. An example opening tag has the form of <X Y>where X is a tag identifier and Y is a unique identifier, and a closing tag has the form of </X>.

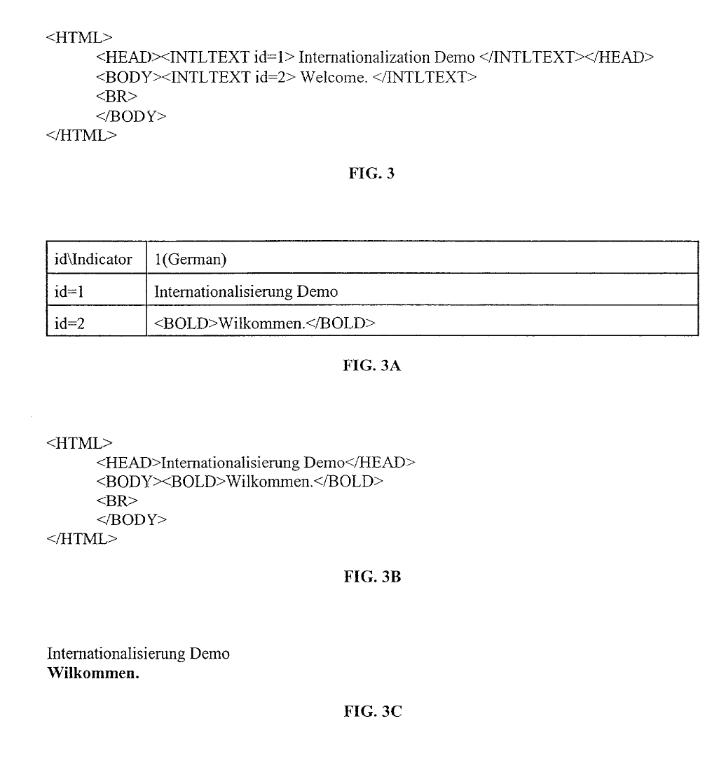

In an internationalization embodiment, such as illustrated in FIG. 3, the opening tag may be a novel internationalization tag such as<INTLTEXT id=Z> and the closing tag may be a novel internationalization tag such as</INTLTEXT>, where Z is a unique number and id=Z is the unique identifier. The unique identifiers are used to mark specific identified sections of text for substitution by specific corresponding replacement sections of an indicated language and the unique number is what distinguishes one unique identifier from another. As depicted in FIG. 3, the heading between the HTML tags <HEAD> and </HEAD> may be marked by placing tags <INTLTEXT id=1> and </INTLTEXT> around the heading; and the text between the HTML tags <BODY> and </BODY> may be marked by placing HTML, tags <INTLTEXT id=2> and </INTLTEXT> around a section of text in the body. Information that does not need to be internationalized, such as the HTML line break code <BR>, is not marked. It is understood that the novel internationalization tags can be essentially any unique identifier, however, using HTML-type tags may facilitate compatibility with existing systems.

At step 204, the file containing the sections marked in step 202, i.e., the marked file, is identified by the novel parser program for filtering in accordance with the present invention prior to display on a browser. In one embodiment, the parser program monitors files being sent by a server and identifies the files being sent that are marked files. The parser program may identify the marked files based on their associated Multipurpose Internet Mail Extension (MIME)-types, for example.

MIME-types are well known properties associated with every file for transmission over the WWW, such as the “text/html” MIME-type for HTML files. When a file is transmitted over the WWW, the server transmitting the file inserts a representation of the file's MIME-type at a specified location within a known header field associated with the file being transmitted. The MIME-type of a file being transmitted can then be derived from its header in a well known manner by the parser program.

In one embodiment, the parser program is a Java servlet that operates in the background on a Java enabled server and identifies the marked file by its MIME-type using the well known Java technique of “MIME-type filtering.” MIME-type filtering can be employed to monitor files being sent out of the Java enabled server, and perform processing on the files identified as having a particular MIME-type. For example, if the parser program is set up to MIME-type filter HTML files having a “text/html” MIME-type, the parser program will perform processing on all files being sent by the Java enabled server having a “text/html” MIME-type.

In the internationalization embodiment, a new “internationalization” MIME-type is created for internationalization files. If the marked file has the “internationalization” MIME-type and the parser program is set up to process files having the “internationalization” MIME-type, the parser program will monitor all files that are being sent by the Java enabled server and will process all files having the “internationalization” MIME-type prior to their reaching the browser. As part of its processing, the parser program may change the MIME-type of the internationalization file after processing to a conventional MIME-type such as the “text/html” MIME-type for display at a browser.

At step 206, an indicator is received by the parser program that is used to direct processing by the parser program. In the internationalization embodiment, the indicator is an internationalization indicator received from the browser that indicates the language in which the marked file should be displayed on the browser. The internationalization indicator may be received from the browser through a request by the browser for a marked file. When a browser requests a file, along with the request, the browser sends information in a known manner that identifies the language associated with the user's browser. Requests may be monitored by the parser program operating in the background on the Java enabled server in order to receive the indicator of the language in which the file is to be displayed on the browser.

The language may be associated with the browser via a known setup procedure, which typically occurs when the browser is installed on a computer or the user may select the language associated with the browser using a known setup procedure. In an alternative embodiment, the user may select the language for display on the browser via a web page, which prompts an indicator of the language to be stored in a “cookie” in a known manner. The cookies associated with the browser may be viewed by the parser program using known techniques to determine the indicator when a marked file is requested by the browser.

If the indicator indicates that the language for display on the browser should be English, i.e., the default language, or a language not recognized by the parser program, the indicator is treated as a default indicator. If the indicator indicates that the language for display should be a language recognized by the parser program, which is not the default language, e.g., English, the indicator is used to identify replacement sections in the indicated language that will be substituted for corresponding marked sections.

At step 208, the marked file is filtered using the novel parser program to produce a desired output file for display at a browser. In the internationalization embodiment, the marked file is filtered such that the file will be displayed in the browser's indicated language, if recognized. The steps depicted in FIG. 2A illustrate one embodiment for filtering the marked file.

At step 208A (FIG. 2A), an input stream generated from the marked file is received by the parser program. The input stream is generated in a known manner, as if the marked file were being transmitted directly to the browser rather than being processed by the parser program prior to passage to the browser. In the internationalization embodiment, the input stream contains the “internationalization” MIME-type in a header field.

At step 208B, the parser program checks the indicator to determine the appropriate processing steps to perform. In the internationalization embodiment, the indicator is used to determine the language with which a marked file is to be displayed on a browser. The indicator is compared to the default language of the marked file and the languages recognized by the parser program. If the indicator matches the default language of the marked file or indicates an unrecognized language, the indicator is treated as a default indicator and processing proceeds at step 208C. Alternatively, if the indicator indicates a recognized language indicative of replacement sections in the recognized language for substitution with corresponding sections of the marked file, processing proceeds at step 208D.

At step 208C, the parser program scans the input stream generated from the marked file for unique identifiers and removes them to create an output stream for display on the user's browser. In the internationalization embodiment, the parser program removes all of the internationalization tags from the file. For example, if the internationalization tags are <INTLTEXT id=Z> and </INTLTEXT>, the parser program scans the input stream for these tags and remove them from the input stream to create an output stream for display by the browser. The internationalization tags can be removed efficiently by the parser program, thereby minimizing processing time.

At step 208D, an input stream generated from the marked file is scanned for unique identifiers, and the unique identifiers and the selected sections marked by the unique identifiers are substituted with replacement sections stored in a location accessible by the parser program. The replacement sections may be stored in an array associated with the parser program for quick retrieval by the parser program during processing. In the internationalization embodiment, the parser program replaces all of the internationalization tags and associated sections with corresponding replacement sections, including text and formatting codes, for the language indicated by the indicator.

An example of the substitution of selected sections within a marked file with replacement sections will be described with reference to FIGS. 3, 3A, and 3B. If the indicator received in step 206 indicates the browser's language is German, the replacement sections within the table depicted in FIG. 3A would be substituted for the corresponding internationalization tags and identified sections in an input data stream created from the HTML file depicted in FIG. 3. The parser program monitors the input stream for internationalization tags. When the parser program identifies a first unique opening and closing internationalization tag pair, such as <INTLTEXT id=1> and </INTLTEXT> as shown in FIG. 3, the tag pair and the selected text “Internationalization Demo” marked by the tags are substituted with the corresponding replacement section “Internationalisierung Demo” identified by the indicator, i.e., German, and the unique identifier, i.e., id=1. Likewise, when the parser program identifies a second unique opening and closing internationalization tag pair, such as <INTLTEXT id=2> and </INTLTEXT> as shown in FIG. 3, the tags and the selected text “Welcome.” marked by the tags are substituted with the corresponding replacement section “<BOLD>Wilkommen.<BOLD>” identified by the indicator, i.e., German, and the unique identifier, i.e., id=2. The resultant file after substitution for display at a browser is depicted in FIG. 3B. It should be noted that the internationalization tags are no longer present in the resultant file.

Although replacement sections have been depicted for the German language only, replacement sections for languages other than German may be stored for substitution into the input data stream generated by the marked file. For example, if the indicator indicates the browser's language is Spanish, and corresponding replacement sections exist for the Spanish language, the internationalization tags and associated selected sections would be substituted with corresponding Spanish replacement sections. It is contemplated that the default language could be processed using step 208D rather than step 208C by creating replacement sections for the default language and, also, using the default language replacement sections for unrecognized languages.

At step 208E, an output stream is generated that is capable of being displayed by a browser. In the internationalization embodiment, the parser program generates an output stream that can generate a file for display in a browser's associated language, if recognized. For example, for a default indicator, if an input stream is generated from the marked file depicted in FIG. 3, the output stream from the parser program would generate the file as depicted in FIG. 1, which is capable of displaying the text depicted in FIG. 1A on an English language or an unrecognized language browser. For an indicator indicative of a language recognized for substitution, e.g., German, if an input stream is generated from the marked file depicted in FIG. 3, the output stream from the parser program would generate a file such as depicted in FIG. 3B, which is capable of displaying the text depicted in FIG. 3C on a German language browser. In one embodiment, the MIME-type is changed such that the output stream contains the commonly known “text/html” MIME-type in a header field.

At step 210 (FIG. 2), the file as filtered in step 208 is displayed. In the internationalization embodiment, the file as processed by the parser program is displayed on a browser in the browser's associated language. For example, the file depicted in FIG. 3 will display the English text depicted in FIG. 1A on an English or unrecognized language browser and display the German text depicted in FIG. 3C on a German language browser.

Network

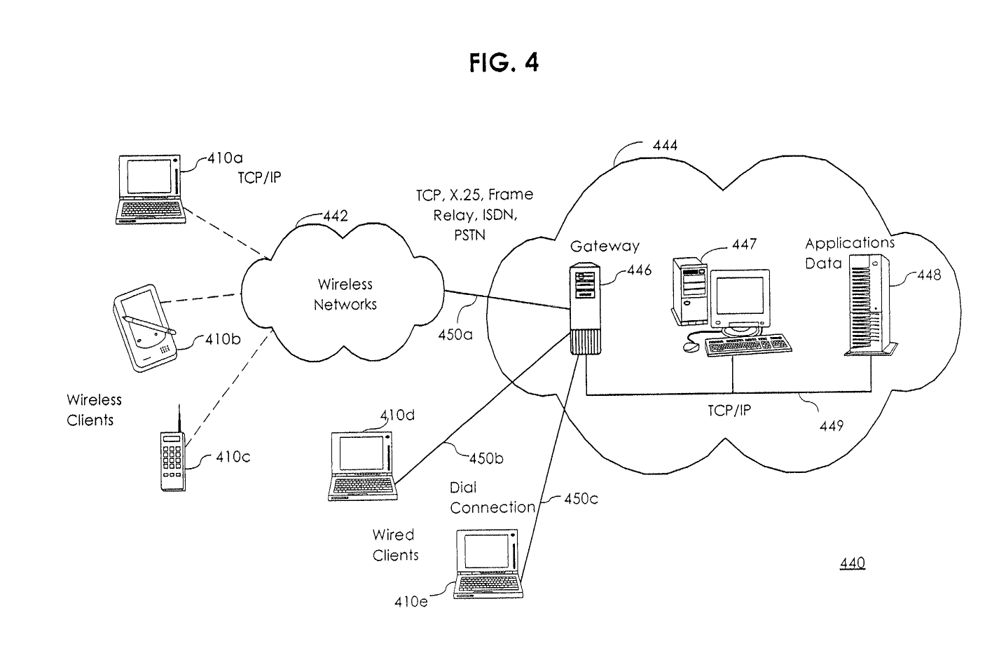

FIG. 4 illustrates an exemplary data processing network 440 in which the present invention may be practiced. The data processing network 440 may include a plurality of individual networks, such as wireless network 442 and network 444, each of which may include a plurality of individual workstations/devices, e.g. 410a, 410b, 410c. Additionally, as those skilled in the art will appreciate, one or more LANs may be included (not shown), where a LAN may comprise a plurality of intelligent workstations coupled to a host processor.

The networks 442 and 444 may also include mainframe computers or servers, such as a gateway computer 446 or application server 447 (which may access a data repository 448). A gateway computer 446 serves as a point of entry into each network 444. The gateway computer 446 may be preferably coupled to another network 442 by means of a communications link 450a. The gateway computer 446 may also be directly coupled to one or more workstations, e.g 410d, 410e using a communications link 450b, 450c. The gateway computer 446 may be implemented using any appropriate processor, such as IBM's Network Processor. For example, the gateway computer 446 may be implemented using an IBM pSeries (RS/6000) or xSeries (Netfinity) computer system, an Enterprise Systems Architecture/370 available from IBM, an Enterprise Systems Architecture/390 computer, etc. Depending on the application, a midrange computer, such as an Application System/400 (also known as an AS/400) may be employed. (“Enterprise Systems Architecture/370” is a trademark of IBM; “Enterprise Systems Architecture/390,” “Application System/400,” and “AS/400” are registered trademarks of IBM.) These are merely representative types of computers with which the present invention may be used.

The gateway computer 446 may also be coupled 449 to a storage device (such as data repository 448). Further, the gateway 446 may be directly or indirectly coupled to one or more workstations/devices 410d, 410e, and servers such as application server 447.

Those skilled in the art will appreciate that the gateway computer 446 may be located a great geographic distance from the network 442, and similarly, the workstations/devices may be located a substantial distance from the networks 442 and 444. For example, the network 442 may be located in California, while the gateway 446 may be located in Texas, and one or more of the workstations/devices 410 may be located in New York. The workstations/devices 410 may connect to the wireless network 442 using a networking protocol such as the Transmission Control Protocol/Internet Protocol (“TCP/IP”) over a number of alternative connection media, such as cellular phone, radio frequency networks, satellite networks, etc. The wireless network 442 preferably connects to the gateway 446 using a network connection 450a such as TCP or UDP (User Datagram Protocol) over IP, X.25, Frame Relay, ISDN (Integrated Services Digital Network), PSTN (Public Switched Telephone Network), etc. The workstations/devices 410 may alternatively connect directly to the gateway 446 using dial connections 450b or 450c. Further, the wireless network 442 and network 444 may connect to one or more other networks (not shown), in an analogous manner to that depicted in FIG. 4.

The present invention may be used on a client computer or server in a networking environment, or on a standalone workstation. (Note that references herein to client and server devices are for purposes of illustration and not of limitation: the present invention may also be used advantageously with other networking models.) When used in a networking environment, the client and server devices may be connected using a “wireline” connection or a “wireless” connection. Wireline connections are those that use physical media such as cables and telephone lines, whereas wireless connections use media such as satellite links, radio frequency waves, and infrared waves. Many connection techniques can be used with these various media, such as: using the computer's modem to establish a connection over a telephone line; using a LAN card such as Token Ring or Ethernet; using a cellular modem to establish a wireless connection; etc. The workstation or client computer may be any type of computer processor, including laptop, handheld or mobile computers; vehicle-mounted devices; desktop computers; mainframe computers; etc., having processing (and, optionally, communication) capabilities. The server, similarly, can be one of any number of different types of computer which have processing and communication capabilities. These techniques are well known in the art, and the hardware devices and software which enable their use are readily available.

Processing Device

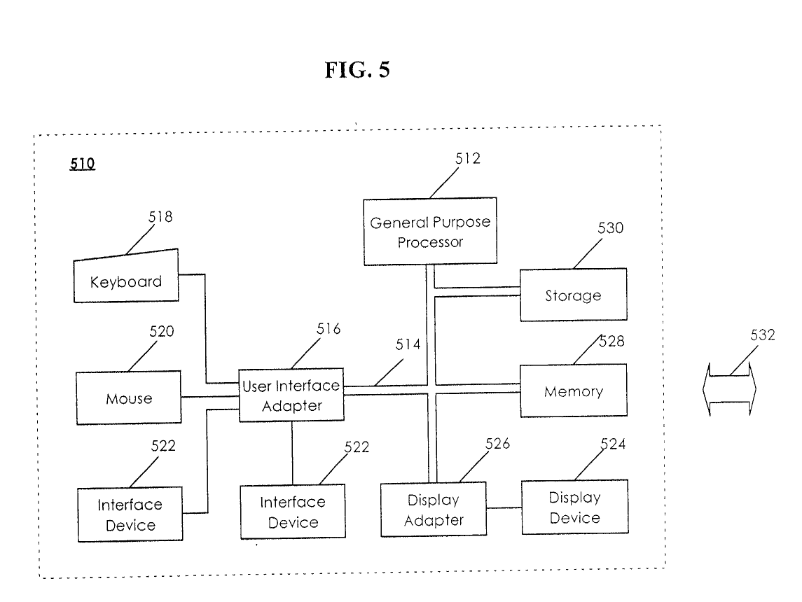

FIG. 5 is a block diagram of a processing device 510 in accordance with the present invention. The exemplary processing device 510 is representative of workstation 410a or server 446 of FIG. 4, as discussed above. This block diagram represents hardware for a local implementation or a remote implementation.

As is well known in the art, the workstation of FIG. 5 includes a representative processing device, e.g. a single user computer workstation 510, such as a personal computer, including related peripheral devices. The workstation 510 includes a general purpose microprocessor 512 and a bus 514 employed to connect and enable communication between the microprocessor 512 and the components of the workstation 510 in accordance with known techniques. The workstation 510 typically includes a user interface adapter 516, which connects the microprocessor 512 via the bus 514 to one or more interface devices, such as a keyboard 518, mouse 520, and/or other interface devices 522, which can be any user interface device, such as a touch sensitive screen, digitized entry pad, etc. The bus 514 also connects a display device 524, such as an LCD screen or monitor, to the microprocessor 512 via a display adapter 526. The bus 514 also connects the microprocessor 512 to memory 528 and long-term storage 530 (collectively, “memory”) which can include a hard drive, diskette drive, tape drive, etc.

The workstation 510 may communicate with other computers or networks of computers, for example, via a communications channel or modem 532. Alternatively, the workstation 510 may communicate using a wireless interface at 532, such as a CDPD (cellular digital packet data) card. The workstation 510 may be associated with such other computers in a LAN or a wide area network (WAN), or the workstation 510 can be a client in a client/server arrangement with another computer, etc. All of these configurations, as well as the appropriate communications hardware and software, are known in the art.

Having thus described a few particular embodiments of the invention, various alterations, modifications, and improvements will readily occur to those skilled in the art. For example, the present invention could be used to modify formatting or content based on preferences other than language, such as a user's preferences as to color or text size. In addition, languages for display may be based on a user's locale or some other identifier. Such alterations, modifications, and improvements are included in this disclosure and are intended to be part of this description though not expressly stated herein, and are intended to be within the spirit and scope of the invention. Accordingly, the foregoing description is by way of example only, and not limiting. The invention is limited only as defined in the following claims and equivalents thereto.

What is claimed is:

1. A method for internationalizing files for display on a browser comprising the steps of:
identifying a file having a first section marked with a first identifier;
receiving a language indicator;
removing said first identifier from said first marked section prior to displaying said file on the browser if said language indicator is a default language indicator; and
substituting said first identifier and said first marked section with a first replacement section corresponding to said language indicator prior to displaying said file on the browser if said language indicator is not said default language indicator.

2. The method of claim 1, wherein said identifying step comprises the steps of:
monitoring files being sent by a server; and
identifying files being sent having an internationalization MIME-type.

3. The method of claim 2, wherein said monitoring and identifying files steps are performed using MIME-type filtering.

4. The method of claim 1, wherein said removing step comprises the steps of:
receiving an input stream based on said file;
scanning said input stream for said first identifier; and
removing said first identifier from said first marked section in said input stream to generate an output stream for display on the browser.

5. The method of claim 1, wherein said substituting step comprises the steps of:
receiving an input stream based on said file;
scanning said input stream for said first identifier; and
substituting said first identifier and said first marked section in said input stream with said first replacement section to generate an output stream for display on the browser.

6. A method for manipulating files comprising the steps of:
identifying a file having a first section marked with a first identifier;
receiving an indicator; and
filtering said file to modify said first section marked with said first identifier based on said indicator.

7. The method of claim 6, wherein said filtering step comprises:
substituting said first identifier and said first marked section with a first replacement section corresponding to said indicator.

8. The method of claim 6, wherein said filtering step comprises:
removing said first identifier from said first marked section if said indicator is a default indicator; and
substituting said first identifier and said first marked section with a first replacement section corresponding to said indicator if said indicator is not said default indicator.

9. The method of claim 8, wherein said removing step comprises the steps of:
receiving an input stream based on said file;
scanning said input stream for said first identifier; and
removing said first identifier from said first marked section in said input stream to generate an output stream for display on a browser.

10. The method of claim 8, wherein said substituting step comprises the steps of:
receiving an input stream based on said file;
scanning said input stream for said first identifier; and
substituting said first identifier and said first marked section in said input stream with said first replacement section to generate an output stream for display on a browser.

11. The method of claim 8, wherein said first section includes text and formatting codes.

12. The method of claim 8, wherein said replacement section includes text and formatting codes.

13. The method of claim 8, wherein said file is an XML file.

14. The method of claim 8, wherein said file is an HTML file.

15. The method of claim 8, wherein said first identifier comprises an opening tag having a unique indicator preceding said first section and a closing tag following said first section.

16. The method of claim 15, wherein said opening tag is <X Y> and said closing tag is </X>, wherein X is a tag and Y is said unique indicator.

17. The method of claim 8, said file further having a second section marked with a second identifier, said method further comprising the steps of:
removing said second identifier from said second section if said indicator is a default indicator; and
substituting said second section with a second replacement sections corresponding to said indicator if said indicator is not said default indicator.

18. A system for internationalizing files for display on a browser, said system comprising:
means for identifying a file having a first section marked with a first identifier;
means for receiving a language indicator;
means for removing said first identifier from said first marked section prior to displaying said file on the browser if said language indicator is a default language indicator; and
means for substituting said first identifier and said first marked section with a first replacement section corresponding to said language indicator prior to displaying said file on the browser if said language indicator is not said default language indicator.

19. The system of claim 18, wherein said means for identifying comprises:
means for monitoring files being sent by a server; and
means for identifying files being sent having an internationalization MIME-type.

20. The method of claim 18, wherein said means for removing comprises:
means for receiving an input stream based on said file;
means for scanning said input stream for said first identifier; and
means for removing said first identifier from said first marked section in said input stream to generate an output stream for display on the browser.

21. The method of claim 18, wherein said means for substituting comprises:
means for receiving an input stream based on said file;
means for scanning said input stream for said first identifier; and
means for substituting said first identifier and said first marked section in said input stream with said first replacement section to generate an output stream for display on the browser.

22. A computer program product for internationalizing files for display on a browser, said computer program product comprising:
computer readable program code embodied in a computer readable medium, the computer readable program code comprising at least:
computer readable program code for identifying a file having a first section marked with a first identifier;
computer readable program code for receiving a language indicator;
computer readable program code for removing said first identifier from said first marked section if said language indicator is a default language indicator; and
computer readable program code for substituting said first identifier and said first marked section with a first replacement section corresponding to said language indicator if said language indicator is not said default language indicator.

23. The system of claim 22, wherein said computer readable program code for identifying comprises:
computer readable program code for monitoring files being sent by a server; and
computer readable program code for identifying files being sent having an internationalization MIME-type.

24. The method of claim 22, wherein said computer readable program code for removing comprises:
computer readable program code for receiving an input stream based on said file;
computer readable program code for scanning said input stream for said first identifier; and
computer readable program code for removing said first identifier from said first marked section in said input stream to generate an output stream for display on the browser.

25. The method of claim 22, wherein said computer readable program code for substituting comprises:
computer readable program code for receiving an input stream based on said file;
computer readable program code for scanning said input stream for said first identifier; and
computer readable program code for substituting said first identifier and said first marked section in said input stream with said first replacement section to generate an output stream for display on the browser.
